(19) United States
(12) Patent Application Publication
(10) Pub. No.: US 2005/0240502 A1
(43) Pub. Date: Oct. 27, 2005

(54) Dynamically adjusting online bidding method

(76) Inventors: Cheng-Hsing Liao, Taoyuan County (TW); Li-Hwa Lin, Taoyuan County (TW)

Correspondence Address: HARNESS, DICKEY & PIERCE, P.L.C., P.O. BOX 8910, RESTON, VA, 20195, US

(21) Appl. No.: 10/830,061

(22) Filed: Apr. 23, 2004

(51) Int. Cl. G06F 17/60

(52) U.S. Cl. 705/37

(57) ABSTRACT

An online bidding method includes an online bidding system established on a web server for a purchaser to publish at least an inquiring item, and a plurality of suppliers to compete the bids. The method includes the following steps. Receive inquiry information of at least a bid item registered by an inquirer. Store each bid item in a respective databank in the web server. When receive bid information from a bidder, store the information in the correspondent bid item databank. Calculate the rank of initial bids of all bidders according to the initial bid prices and the preset weightings. Store the rank in the correspondent bid item databank. The bidders update their bids with the specific reduction ratio. Then, the system stores the data in the correspondent bid item databank, and updates the rank by the newest bid prices and the preset weightings.

### BACKGROUND OF THE INVENTION

1. Field of the Invention

The invention generally relates to an online bidding method, and in particular relates to an online bidding method with dynamic adjustment.

2. Related Art

As Scott McNealy, chief executive of Sun Microsystem, Inc., said, Internet is biggest marketplace on the world. E-commerce through Internet is a kind of nationwide or worldwide activity. “Online bidding” has been a new trend of trade on the web. There is no limitation on location and time for the seller and the buyer. The inquiry, quotation and trading is easy and fast. A reasonable and satisfied price can be obtained through the interactions, and trades can be settled with high efficiency. Through online bidding, offers and purchases are available 24 hours a day and 7 days a week. The market prices are dynamically suited according to the supplies and the needs, and are usually beneficial to both suppliers and buyers without a charge on the intermittent channels.

As described above, online bidding is turning into a valuable tool of trade that vendors and their partners are delightedly participating.

### SUMMARY OF THE INVENTION

The object of the invention is to provide a dynamically adjusting online bidding method through which the buyer can get a purchasing item with a reasonable price. The process is efficient and saves time and efforts.

An online bidding method according to the invention includes an online bidding system established on a web server for an inquirer (purchaser) to publish at least an inquiring item; and a plurality of suppliers to compete the bids. The method includes the following steps. Receiving inquiry information of at least a bid item registered by an inquirer. The inquiry information includes specifications, quantities, bid price settings and preset weightings for bidders. Each bid item is stored in a respective databank in the web server. When receiving bid information from a bidder, storing the bid information in the correspondent bid item databank. The bid information includes the will of bid or not, and an initial bid price. Calculate the rank of initial bids of all bidders according to the initial bid prices and the preset weightings. Store the rank in the correspondent bid item databank. The bidders update their bids with some reduction ratios. Then, the system stores the data in the correspondent bid item databank, and updates the rank by the newest bid prices and the preset weightings.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a composition diagram of an online bidding system using the method of the invention; and

FIG. 2 is a flowchart of an online bidding method of the invention.

### DETAILED DESCRIPTION OF THE INVENTION

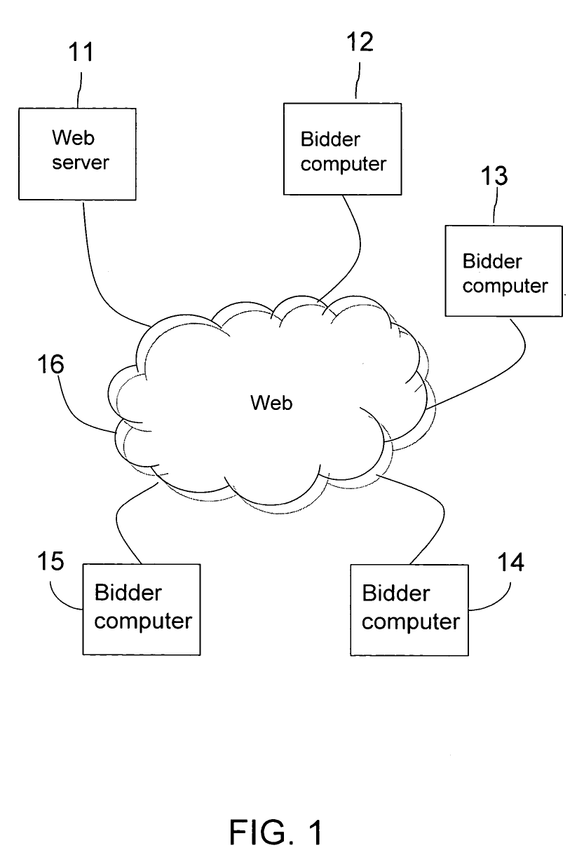

FIG. 1 is an example of an online bidding system applying the method of the invention. An inquirer (purchaser) publishes inquiry information through a web server 11. The inquiry information for a bid item includes specifications, quantities, bid starting time and ending time, number of bid-gainer to be chosen, and the minimum price reduction percentage of the next bid. After the inquiry information being finished, it is transferred via the web 16 to all of the registered bidders (suppliers). For example, informing through emails to the remote computers 12, 13, 14, 15 of the bidders. The bidders can link to the web sever 11 and register their bid information, such as the will of bid or not, specifications and quantity for the bid item, and an initial bid price. When the bid starts, the web server 11 calculates the rank of initial bids of all bidders according to the initial bid prices and the preset weightings for bidders. Then, informs the rank to each bidder via the web 16. The bidders update their bids with some reduction ratios. Then, the system stores the data in the correspondent bid item databank, and updates the rank by the newest bid prices and the preset weightings. The updating continues till the bidding time ends. The inquirer can notice each bidder the rank through the web server 11, and decide to close the bidding earlier or decide the final bid-gainer when the bidding ends. The inquirer can set weightings for each bidder through the web server 11. For example, a certified bidder gets a higher weighting; and an uncertified bidder gets a lower weighting. The rank is based on multiplications of the bid prices and the weightings of the bidders.

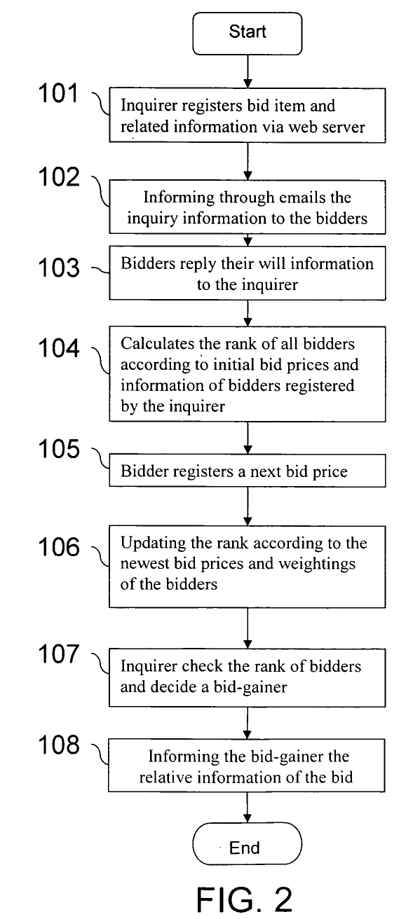

FIG. 2 is a flowchart of an online bidding method of the invention. First, the inquirer registers the bid item and related information in a respective databank through the web server (step 101). The inquiry information includes specifications, quantities, bid starting time and ending time, number of bid-gainer to be chosen, and the minimum price reduction ratio of the next bid. The minimum price reduction ratio set by the inquirer limits the minimum price reduction percentage for the bidder. For example, if an initial bid price is 5,000, and the minimum reduction ratio is 5%, then the next bid price shall not exceed 4,750; and the further next bid price shall not exceed 4,512.5. The inquiry information is stored in a respective databank through the web server. The inquirer also registers information of bidders (suppliers) in the bid item databank. Then, informs through emails the inquiry information to the bidders (step 102).

The bidders receiving and reviewing the inquiry information reply their will information via the web server to the inquirer (step 103). The will information includes the will of bid or not, specifications and quantity for the bid item, and an initial bid price. The bid information is stored in the correspondent bid item databank.

The system calculates the rank of all bidders according to the initial bid prices and the information of bidders registered by the inquirer (step 104). The information of bidders includes weightings for each bidder. For example, a certified bidder gets a higher weighting; and an uncertified bidder gets a lower weighting. The rank is judged first by the weightings then by the bid prices; or first by the bid prices then the weightings, depending on the setting of the inquirer.

The rank of the bidders is stored into the bid item databank for the inquirer to check and inform each bidder the respective rank. Then, the bidder can register a next bid price under the setting of bidding (such as the minimum price reduction ratio) (step 105). The updated bid price is stored in the bid item databank.

Whenever there is an updated bid price in the databank, the system re-calculates the rank according to the newest bid prices and weightings of the bidders, updates the data in the databank, and informs each bidder the updated rank (step 106).

The aforesaid steps 105 and 106 repeat till the bidding ends. The bidding is automatically extended for 1 minute if there is a bid price being updated in the last minute. The times of extension are unlimited. The inquirer has the right to extend the bidding time or to close the bidding earlier. When the bidding ends, the inquirer gets the final rank of bidders and decides a bid-gainer (step 107). After the bid-gainer being decided, informing the bid-gainer the relative information of the bid (step 108), such as the specifications and quantity of the bid item, the starting and ending time of the bidding, numbers of bid-gainer, the minimum reduction ratio of bidding, the initial bid price, the final bid price and the total reduction ratio, etc.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A dynamically adjusting online bidding method, applicable to an online bidding system established on a web server, for providing a plurality of bidders bidding on at least a bid item registered by an inquirer, comprising steps of:
receiving inquiry information registered by said inquirer for at least a bid item; said inquiry information comprises specifications and quantity of said bid item, bid price setting and preset weightings for each bidder;
storing said inquiry information in correspondent bid item databank;
receiving bidding will information from bidders; each will information comprises a will to attend the bidding and an initial bid price;
storing said will information in correspondent bid item databank;
ranking all bidders by said initial bid prices and weightings of said bidders, and storing said rank in correspondent bid item databank;
receiving at least a bid price reduction ratio registered by a bidder, and storing in correspondent bid item databank; and
updating new rank of bidders according to all newest bid prices and weightings of bidders, and storing said updated rank in correspondent bid item databank.

2. The dynamically adjusting online bidding method according to claim 1 wherein said inquiry information comprises specifications of said bid item.

3. The dynamically adjusting online bidding method according to claim 1 wherein said inquiry information comprises quantity of said bid item.

4. The dynamically adjusting online bidding method according to claim 1 wherein said inquiry information comprises starting time and ending time of bidding.

5. The dynamically adjusting online bidding method according to claim 1 wherein said bidding setting comprises a minimum reduction ratio of bid price for a next bidding.

6. The dynamically adjusting online bidding method according to claim 1 further comprises a step of informing at least a bid-gainer a final bidding result by said inquirer via said web.

7. The dynamically adjusting online bidding method according to claim 6 wherein said final bidding result comprises specifications and quantity of bid item, starting and ending time of bidding, number of bid-gainer, a minimum reduction ratio of bid price for a next bidding, and initial bid price, final bid price and total bid price reduction ratio of said bid-gainer.

8. The dynamically adjusting online bidding method according to claim 1 further comprises a step of closing said bidding by said inquirer.

9. The dynamically adjusting online bidding method according to claim 1 further comprises a step of extending said bidding by said inquirer.

10. The dynamically adjusting online bidding method according to claim 1 further comprises a step of setting a weighting for a bidder according to quality of bid item provided by said bidder.

11. The dynamically adjusting online bidding method according to claim 10 wherein a bidder is set with a higher weighting when said bid item provided by said bidder is certified.

12. The dynamically adjusting online bidding method according to claim 10 wherein a bidder is set with a lower weighting when said bid item provided by said bidder is uncertified.

13. The dynamically adjusting online bidding method according to claim 1 further comprises a step of informing inquiry information to any a bidder by said inquirer via said web.

14. The dynamically adjusting online bidding method according to claim 1 further comprises a step of real time informing each bidder said updated rank of said bidder.
